(19) United States
(12) Patent Application Publication
(10) Pub. No.: US 2017/0200096 A1
(43) Pub. Date: Jul. 13, 2017

(54) INTEGRATED TICKET MANAGEMENT AND EXCHANGE SYSTEM AND METHOD

(71) Applicant: All Calendars, LLC, N. Richland Hills, TX (US)

(72) Inventor: Charles Daniel Cocanougher, City of Lake Bridgeport, TX (US)

(21) Appl. No.: 15/471,039

(22) Filed: Mar. 28, 2017

Related U.S. Application Data
(63) Continuation-in-part of application No. 14/698,435, filed on Apr. 28, 2015.
(60) Provisional application No. 61/985,147, filed on Apr. 28, 2014.

(51) Int. Cl. G06Q 10/02; G06Q 20/02; G06Q 10/10

(52) U.S. Cl. CPC G06Q 10/02; G06Q 10/1095; G06Q 20/02

(57) ABSTRACT

A system and method are disclosed for establishing and maintaining a shared, flexible electronic-calendar network with varying permission, notification, sharing, and functionality options, In some implementations, an integrated, flexible, electronic calendar system and method may enable users and groups to acquire, maintain, and share tickets associated with calendared events.

### RELATED APPLICATION DATA

This application is a continuation-in-part of, and claims priority from, co-pending U.S. patent application Ser. No. 14/698,435 filed Apr. 28, 2015, and also claims benefit of the filing date of U.S. provisional patent application Ser. No. 61/985,147 filed on Apr. 28, 2014; the content of these applications is hereby incorporated in its entirety.

### BACKGROUND

1. Field

The present disclosure relates generally to the field of electronic calendars and, more particularly, to an integrated, flexible, electronic calendar system and method that enable users and groups to acquire, maintain, and share tickets associated with calendared events.

2. Description of the Related Art

Electronic calendars, or e-calendars, are commonly used in business organizations to schedule and manage work events, as well as in a personal context to help users manage appointments and other personal obligations. Most e-calendars used in the workplace are tailored to a corporate environment, prioritizing standardization, control, and consistency over flexibility and user-friendliness. In a private or personal context, typical e-calendar applications, even those that allow family members or groups of friends to view calendar events and accept calendar invitations, are geared towards standardization and focused on the event creator's agenda. For example, in a typical e-calendar, if a user creates an event and invites another user to the event, the invitee generally has no ability to modify the details of the event.

In practice, many people who use e-calendars for work do not maintain separate e-calendars for their personal life. One reason for this is that e-calendars designed for personal use still maintain much of the rigidity and inflexibility of workplace e-calendars, as noted abo e. Therefore, many people simply use their work related e-calendar to schedule and manage personal events as well. This creates a problem for users and groups who would like to have more flexibility in the creation, management, and sharing of events than typical work e-calendars offer. Moreover, using a single e-calendar to manage and schedule each aspect of one's life has significant privacy implications.

As set forth in detail in co-pending U.S. patent application Ser. No. 14/698,435, a person who does endeavor to keep separate e-calendars faces substantial integration and management problems when dealing with calendar applications developed by different companies, for different purposes, and with different permissions, sharing, and other functionality. For example, consider an individual who uses Microsoft Outlook™ at work and keeps a separate iCal™ calendar for personal use. To add a work event to an independent personal calendar, the individual would need manually to update the personal calendar. If the start time of the work event were later modified, the user would need manually to update the start time of the work event in the personal calendar to maintain accuracy.

Further, conventional calendaring applications do not take into consideration events or calendared activities for which an admission ticket or other admission token is required. Many events that are memorialized on a calendar require some form of authorization for admission—educational or business conventions, symposia, trade shows, music concerts, ballet or other arts performances, museum tours, and sporting events are a few examples of calendared events that may require an admission ticket or other documented authorization for attendance. In many instances, such tickets or admission authorizations require payment or barter to obtain.

While electronic currency exchange and barter systems and methods are generally known, none is efficiently and conveniently integrated with e-calendar functionality such that an acquired ticket or admission token is associated with the event scheduled on the calendar and may readily be transferred or otherwise conveyed to another user scheduled to attend the associated event.

### SUMMARY

The disclosed system and method overcome the foregoing and various other shortcomings of conventional technology, providing an enhanced and flexible e-calendar application integrated with ticket management and exchange functionality that enables users and groups to acquire, maintain, and share tickets associated with calendared events.

In accordance with one embodiment, for example, a system for viewing and managing a collection of electronic calendars of a user may generally comprise an interface that enables the user to browse through the collection of electronic calendars and add or remove electronic calendars from the collection of electronic calendars, and a ticket manager that enables the user to associate a ticket with a particular calendar event using the interface. The ticket manager may allow the user to purchase the ticket, which is required for attendance at the particular calendar event. In some instances, the ticket manager may allow the user to transfer the ticket to a third party; the ticket manager may also allow the third party to provide payment to the user in exchange for the ticket. The system may further comprise an estimated time of arrival (ETA) component that updates the user with information related to a location of a third party that is to attend the particular calendar event associated with the ticket.

In accordance with other aspects of the disclosure, a method of acquiring and managing a ticket may generally comprise: acquiring a ticket on behalf of a ticket holder; associating the ticket with a particular calendar event; confirming the associating with a remote ticket manager component; and enabling the ticket holder to redeem the ticket in exchange for admission to the particular calendar event. In some embodiments, such a method of may further comprise enabling the ticket holder to transferthe ticket to a third party and transmitting data regarding the transfer to the remote ticket manager.

As noted above, the disclosed subject matter overcomes deficiencies of conventional systems by enabling users to create, manage, and exchange tickets or other admission authorizations associated with a particular calendared event.

Those of skill in the art will readily appreciate that the various embodiments described below may be implemented on numerous types of electronic devices such as mobile phones, personal digital assistants (PDAs), laptops, personal computers, tablets, and other electronic devices that have a processor and memory.

### BRIEF DESCRIPTION OF THE DRAWINGS

FIG. 1 is a flow chart depicting the logic flow of an embodiment.

FIG. 2 is a permission chart for a private calendar for an embodiment.

FIG. 3 is a permission chart for a public calendar for an embodiment.

FIG. 4 is a sharing notification chart for a private calendar for an embodiment.

FIG. 5 is an edit notification chart for a private calendar for an embodiment.

FIG. 6 is permission/notification chart for a private calendar for an embodiment.

FIG. 7 is a sharing notification chart for a public calendar for an embodiment,

FIG. 8 is an edit notification chart for a public calendar for an embodiment.

FIG. 9 is permission/notification chart for a public calendar for an embodiment.

FIG. 10 is a screen shot of a view in the user interface in an embodiment.

FIG. 11 is a block diagram illustrating one environment in which ticket management functionality may be integrated with a calendar application.

FIG. 12A is a block diagram illustrating functional blocks of one embodiment of a user device illustrated in FIG. 11.

FIG. 12 B is a block diagram illustrating functional blocks of one embodiment of a ticket manager component illustrated in FIG. 11,

FIG. 13A is a flow diagram illustrating aspects of a method of acquiring and managing a ticket.

FIG. 13B is a flow diagram illustrating aspects of a method of acquiring a ticket as illustrated in FIG. 13A.

FIG. 14 is a flow diagram illustrating aspects of a method of managing a ticket.

FIG. 15 is a flow diagram illustrating aspects of another method of managing a ticket.

### DETAILED DESCRIPTION

Disclosed is a dynamic, flexible e-calendar creation and management system that includes an interface allowing users to easily view, manage, and modify a collection of e-calendars. Additionally or alternatively, an e-calendar application may incorporate or interface with a system and method for creating, managing, and exchanging tickets or other admissions tokens or documentation allowing access to restricted calendared events. Multiple embodiments of the disclosed subject matter are envisioned and will be apparent to a person of skill in the art. Specific embodiments discussed below should not be read to limit the scope of the invention to those particular embodiments,

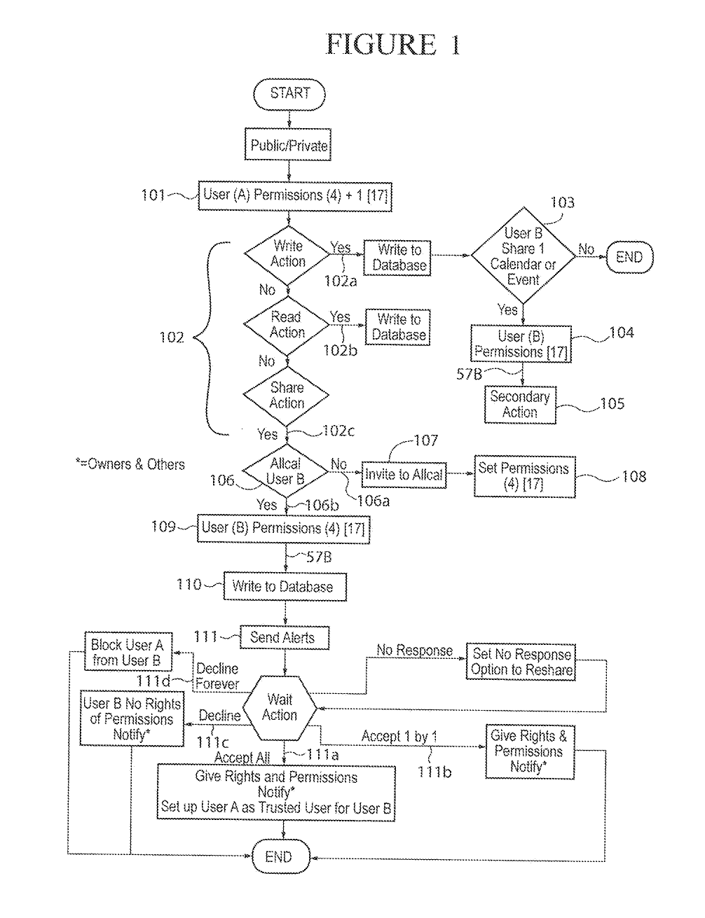

FIG. 1 is a flow diagram depicting the logic flow of an embodiment. As shown in FIG. 1, when User A performs an action on a public or private calendar, the system identifies the permissions of User A at step 101, and then identifies at step 102, whether the intended action is a write action 102a, read action 102b, or share action 102c, and performs the corresponding allowable action. In the instance of a write action 102a, the system checks at step 103 whether the calendar or event written to is shared with other users, such as User B. If so, the system checks at step 104 User B's permissions and, if allowable, performs a secondary action for User B at step 105.

In the instance of a share action 102c with User B, the system first checks at step 106, whether User B is a user of the system. If not 106a, the system invites User B at step 107 and, if User B accepts, User B shares User A's particular calendar (or event) in accordance with the permissions set by User A at step 108. If User B is already a user of the system 106b, the system initiates the share action 110 in accordance with User B's permissions 109 set by User A. The system initiates alert options 111 for User B in accordance with whether User B has decided to accept all share actions 111a from User A, accept share actions on a case-by-case basis 111b, decline the particular share action 111c, or decline all share actions 111d from User A,

The basic logical structure of the method depicted in FIG. 1 allows for the full integration of shared calendars such that calendars that are included in multiple users' collections of calendars can be automatically updated in accordance with the permissions set for that particular calendar, event, and/or user. Specifically, different users see the same instance of the linked calendar. In some embodiments, automatic updates via linkage only occur for a particular user's version if the permissions for the calendar, the event, and/or the user allow for the automatic update.

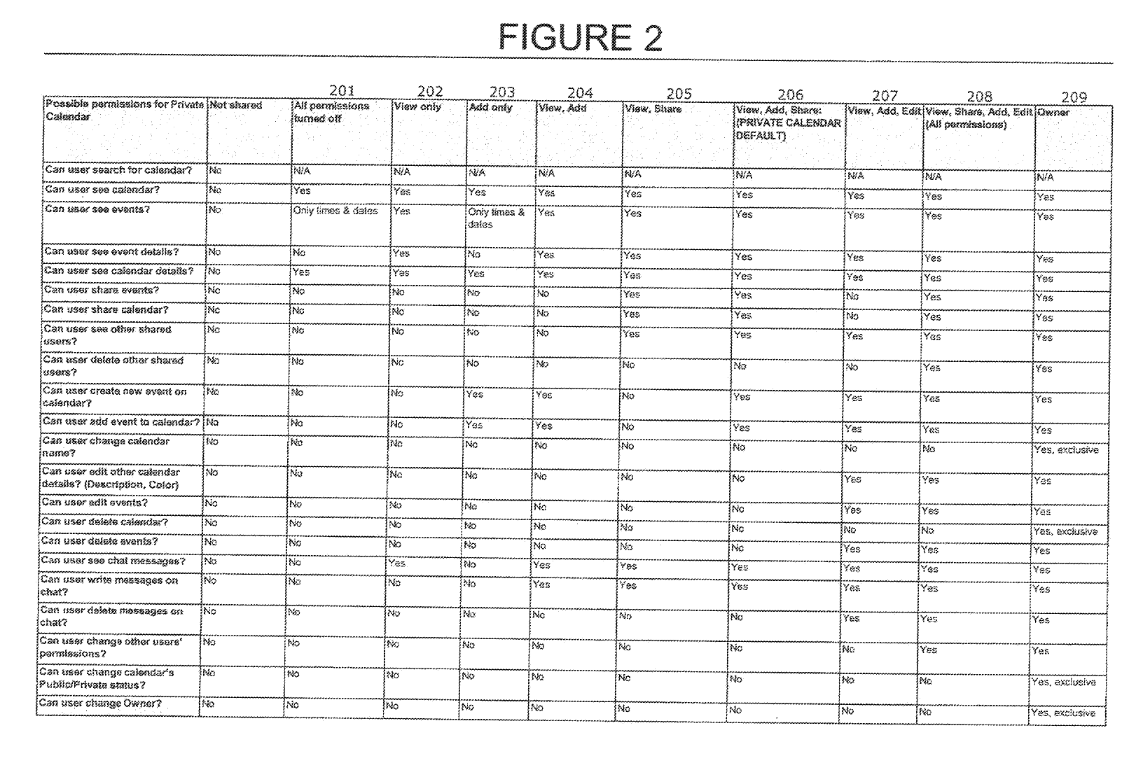

FIG. 2 is a chart describing the permissions for a private calendar in accordance with an embodiment. As shown in FIG. 2, each calendar and/or event can have View, Add, Share, and Edit permissions. For example, if User A's calendar has all permissions turned off 201 for User B, then User B can only see the dates and times of the events in User A's calendar, not the details of those events. If User B has View permissions 202, User B can see the details of User A's events. If User B has Add permissions 203, User B can add events to User A's calendar. Other combinations of these permissions and additional permissions are contemplated. For example, FIG. 2 shows that User B is allowed to write messages on chat if User B has both View and Add permissions 204, but not if User B has only one of these two permissions. In other embodiments, User B can write chat messages without Add permissions. In still other embodiments, User A may override permission defaults such that User B can write messages on chat without Add permissions. Other embodiments include specific permissions for each type of functionality, such as chat or ETA.

Returning to FIG. 2, if User B has View and Share permissions 205, User B can share User A's calendar with others, see other shared users, and utilize chat functionality.

As further shown in FIG. 2, the View, Add, and Share permissions 206 are the default permissions for a private calendar, thought other embodiments are contemplated, If User B has these default permissions, User B can see event details and other users, create new events and add these newly created events to User A's calendar, and engage in chat functionality.

If User A wishes to give User B more control of the calendar, User A can give User B Edit permissions on User A's calendar. For example, as depicted in FIG. 2, with View, Add, and Edit permissions 207, User B cannot only add events to the calendar, but can also edit or delete existing events. User B can also see shared users. However, in this scenario, User B would not be able to share the calendar because User B does not have Share permissions.

If, in addition to View, Add, and Edit permissions, User B also has Share permissions 208, the chart of FIG. 2 shows that User B is allowed to do everything except change the calendar name, change the owner, change the private/public status of the calendar, or delete the calendar altogether. Only the calendar owner 209 has these abilities. It will be appreciated that the matrix depicted in FIG. 2 is provided by way of illustration only, and that other matrices are readily implemented as a function of system administration preferences, corporate policies, personal obligations or requirements, or a combination of these and other factors.

For example, in some implementations, it is also possible to apply each permission to individual events in the calendar. For example, a user may set a work calendar so that nobody outside the workplace can view events during the workday, but after-hours events are viewable or even sharable by others. Alternatively, a user can give only some people edit permissions for some events and only other people edit permissions for other events. The combination of permission options and the ability to apply these permissions at the calendar or event level for each user results in an unlimited number of possibilities and introduces a high degree of flexibility that allows users to craft their calendars and events to meet their specific needs.

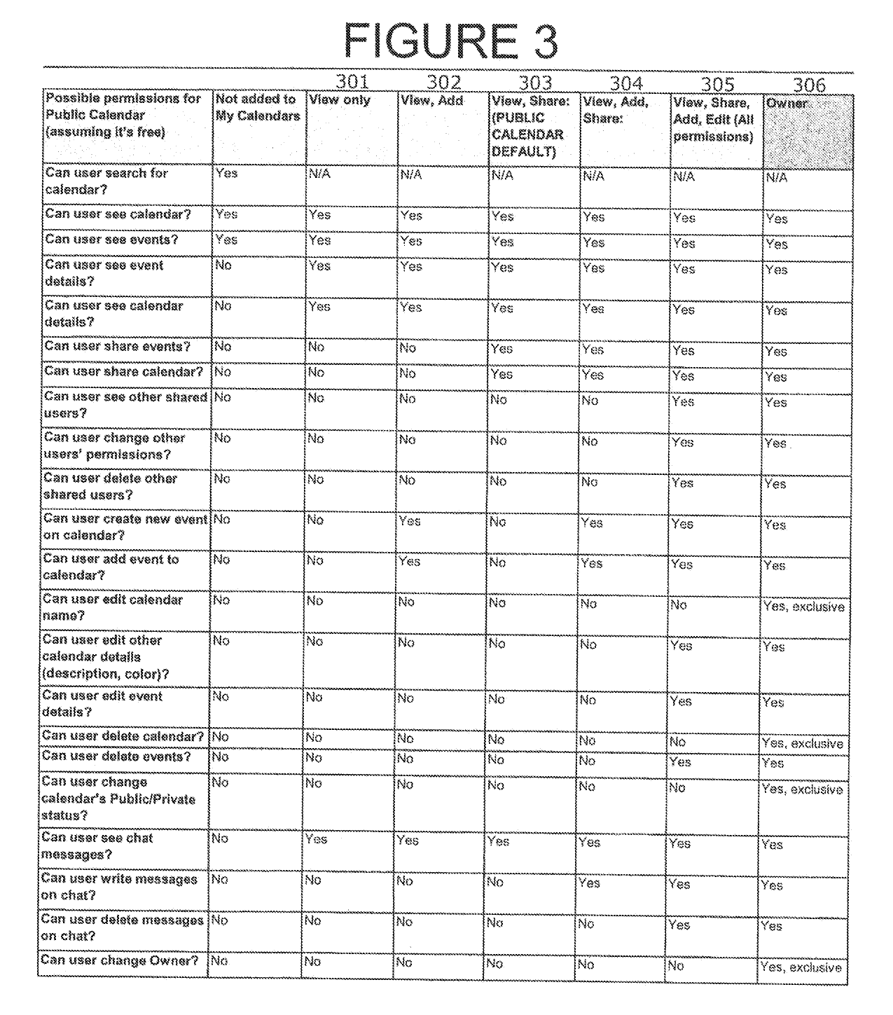

FIG. 3 is a chart describing the permissions for a public calendar in accordance with a further embodiment. In the FIG. 3 embodiment, the default permissions for a public calendar are View and Share 303. Here, only the Owner 306 or a user with all permissions 305 can change other users' permissions. For example, the Owner 306, can restrict a user's permissions to only View 301 or expand the user's permissions to include View, Add, and Share 304. Alternatively, the Owner 306 has the option to change the user's permissions to View and Add 302. In some embodiments, a user of the system can search for a specific public calendar on the system either by calendar name or through a search feature, In further embodiments, the search feature takes into account location and popularity to decide which public calendars are initially shown, or whether these calendars are even shown.

With the default permissions of FIG. 3, by way of example only, public calendars operate in the following manner. It should be understood that the public calendars may operate in other ways, and it is not the intention to limit the invention to the presently described example. In this example, User A searches the system for a Texas Rangers calendar and downloads the calendar to a mobile device. User A can view the Texas Rangers calendar because User A has View permissions. User A also has Share permissions, which allows User A to share the calendar with User B. When User B accepts, User B will also have View and Share permissions. User B then shares the calendar with User C. When User C accepts, Users A, B, and C each have a version of the calendar on their respective electronic device. Users A, B, and C decide to attend a particular game together. To facilitate this, Users A, B, and C each link the calendar event for that game into their personal calendars. If the Texas Rangers calendar changes (e.g. the game is postponed by an hour), the calendar event for the game is automatically updated on each version of the Texas Rangers calendar viewable by the three Users. In addition, each respective personal calendar of the three Users is updated with the event change. In some embodiments, the personal calendar would still be updated, even if each User removed their respective version of the Texas Rangers calendar, because the event that was linked to their personal calendars is still linked to the Texas Rangers calendar. Accordingly, Users A, B, and C are nevertheless notified of the change in the event.

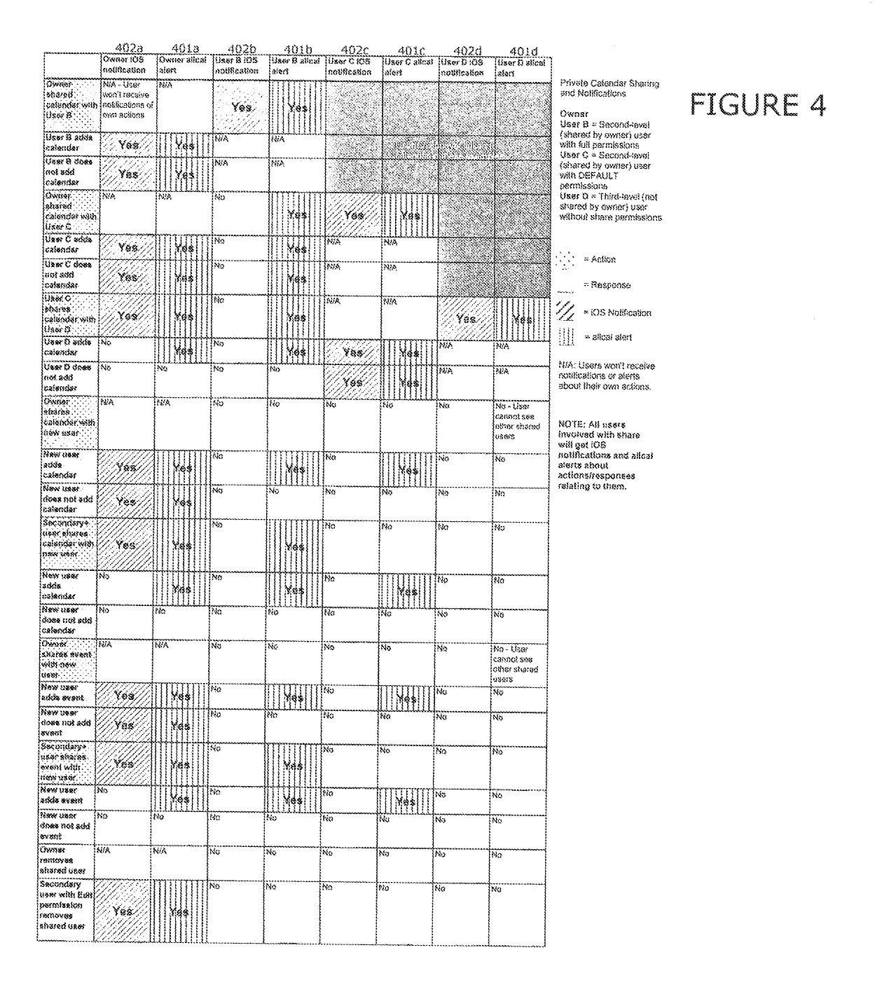

FIGS. 4-9 show notification tables in accordance with disclosed embodiments. In these alternative embodiments, different actions will produce different types of notifications, such as application-based alerts, iOS notifications, and limited versions of each. The level of notification depends upon the relative importance of the update.

In particular, FIG. 4 depicts a sharing notification table for a private calendar in accordance with one embodiment. As shown in FIG. 4, User B will receive an alert 401b and an iOS notification 402b when the User shares a calendar with User B, giving User B full permissions. When User B responds by either adding or declining to add the calendar, the Owner receives an alert 401a, as well as an iOS notification 402a. The Owner may also share the calendar with User C, giving user C default permissions. User C, in turn, may share the calendar with User D, without share permissions. If the Owner then shares the calendar with a new User, who adds the calendar. User C would receive an alert 401c, but not an iOS notification 402 c. User D, however, would not receive either an alert 401d or an iOS notification 402d.

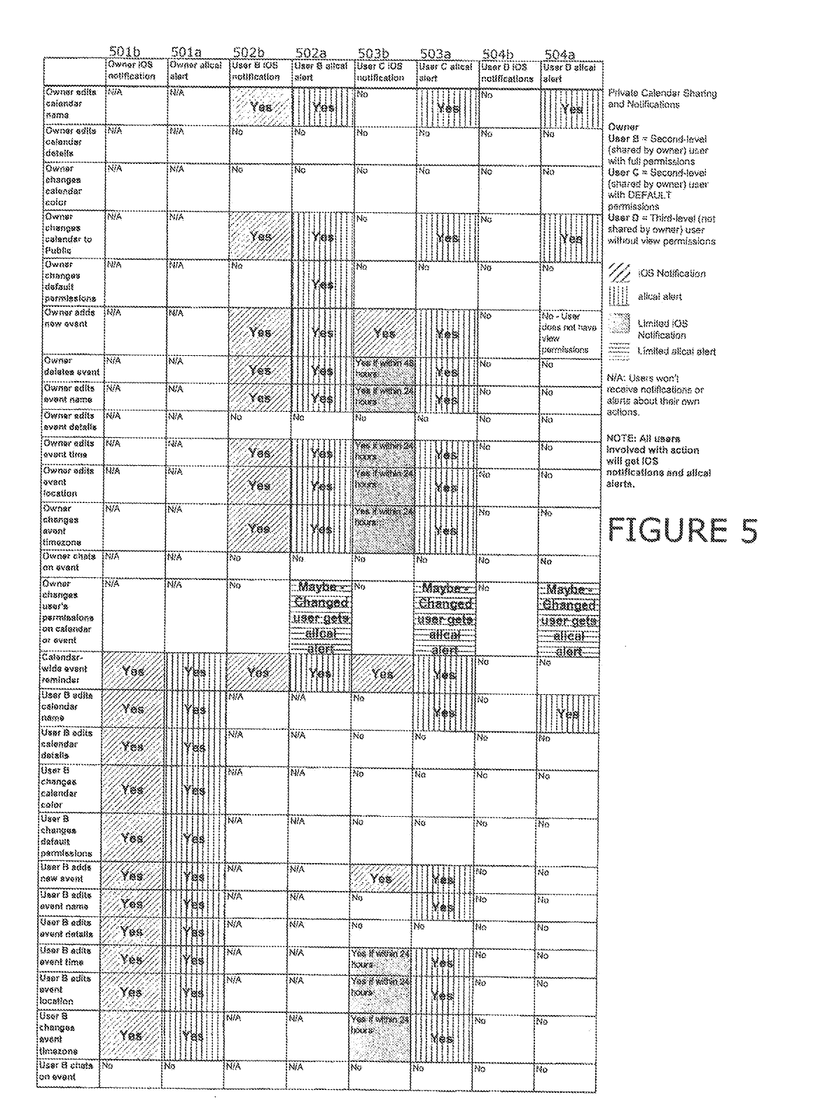

FIG. 5 depicts an edit notification table for a private calendar in one embodiment. As shown in FIG. 5, the Owner has shared a calendar with User B and User C, where giving full permissions and default permissions, respectively. In turn, User C has shared the calendar with User D, who does not have view permissions. With further reference to FIG. 5, if the Owner deletes an event, User B receives both an alert 502a and an iOS notification 502b. User C also receives an alert 503a, but only receives an iOS Notification 503b, in limited circumstances, such as if the event is within 48 hours or in accordance with some other specified criterion. User D, however, would receive neither an alert 504a nor an iOS notification 504b. As also shown in FIG. 5, the Owner of the calendar usually receives both an alert 501a and an iOS notification 501b when other users make changes to the calendar, such as adding a new event or changing an event location.

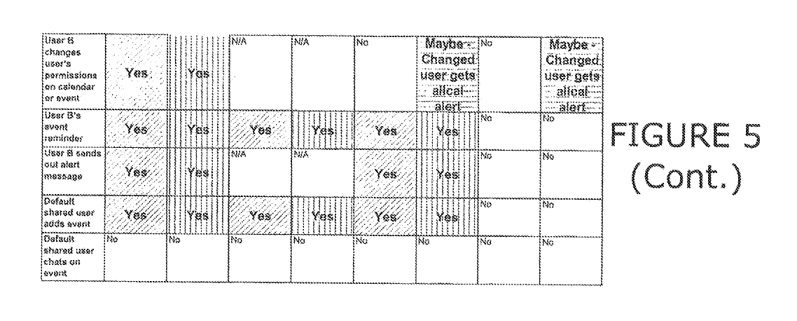

FIG. 6 depicts permissions for a private calendar in accordance with an embodiment. The types of permissions shown in FIG. 6 are: no permissions 601, all permissions turned off 602, View only 603, Add only 604, View and Add 605, View and Share 606, View, Add, and Share 607 (which is the private calendar default in the FIG. 6 embodiment), View, Add, and Edit 608, View, Share, Add, and Edit 609, and Owner permissions 610.

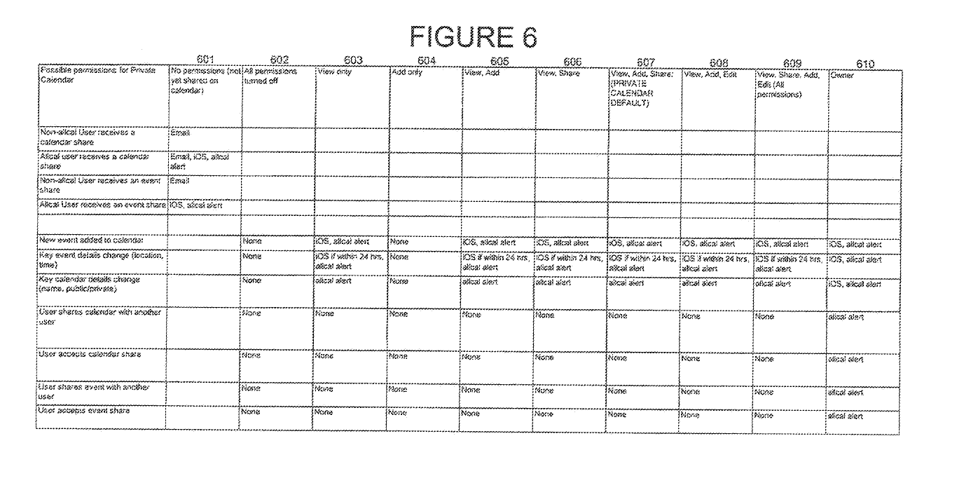

FIG. 7 depicts a sharing notification table for a public calendar in accordance with an embodiment of the invention. As shown in FIG. 7, User B will receive an alert 701b and an iOS notification 702b when the User shares a calendar with User B, giving User B full permissions. When User B responds by either adding or declining to add the calendar, the Owner receives an alert 701a, as well as an iOS notification 702a. The Owner may also share the calendar with User C, giving user C default permissions. User C, in turn, may share the calendar with User D, with default permissions, resulting in User D receiving an alert 701d and an iOS notification 702d. If User D chooses to add the calendar, User C receives both an alert 701c and an iOS notification 702c. However, the owner would receive an alert 701a, but not an iOS notification 702a.

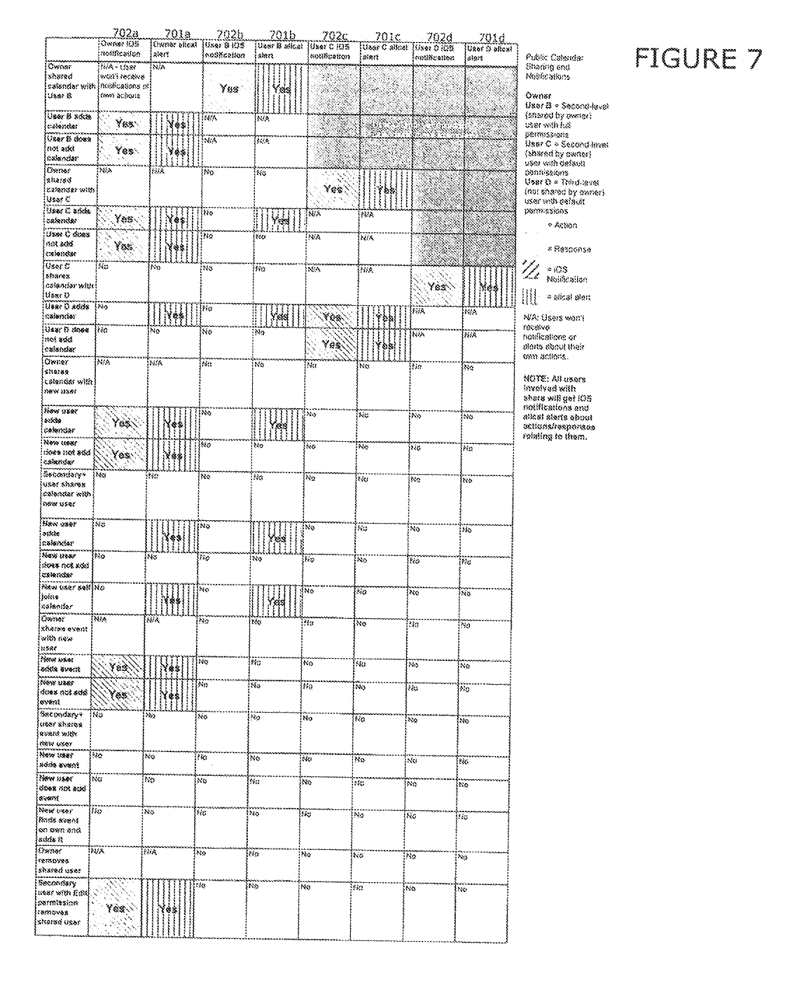

FIG. 8 depicts an edit notification table for a public calendar in accordance with an embodiment of the invention. As shown FIG. 8, the Owner has shared a calendar with User B, giving full permissions, and User C, giving default permissions. In turn, User C has shared the calendar with User D, with default permissions. In FIG. 8, if the Owner deletes an event, User B receives both an alert 802a and an iOS notification 802b. User C also receives an alert 803a, but only receives an iOS Notification 803b, in limited circumstances, such as if the event is within 48 hours or in accordance with some other criterion which may be specified by the Owner. Similarly, User D, receives an alert 804a, but only receives an iOS Notification 804b, in limited circumstances. In FIG. 8, the Owner of the calendar usually receives both an alert 801a and an iOS notification 801b when other users make changes to the calendar, such as adding a new event or changing an event location.

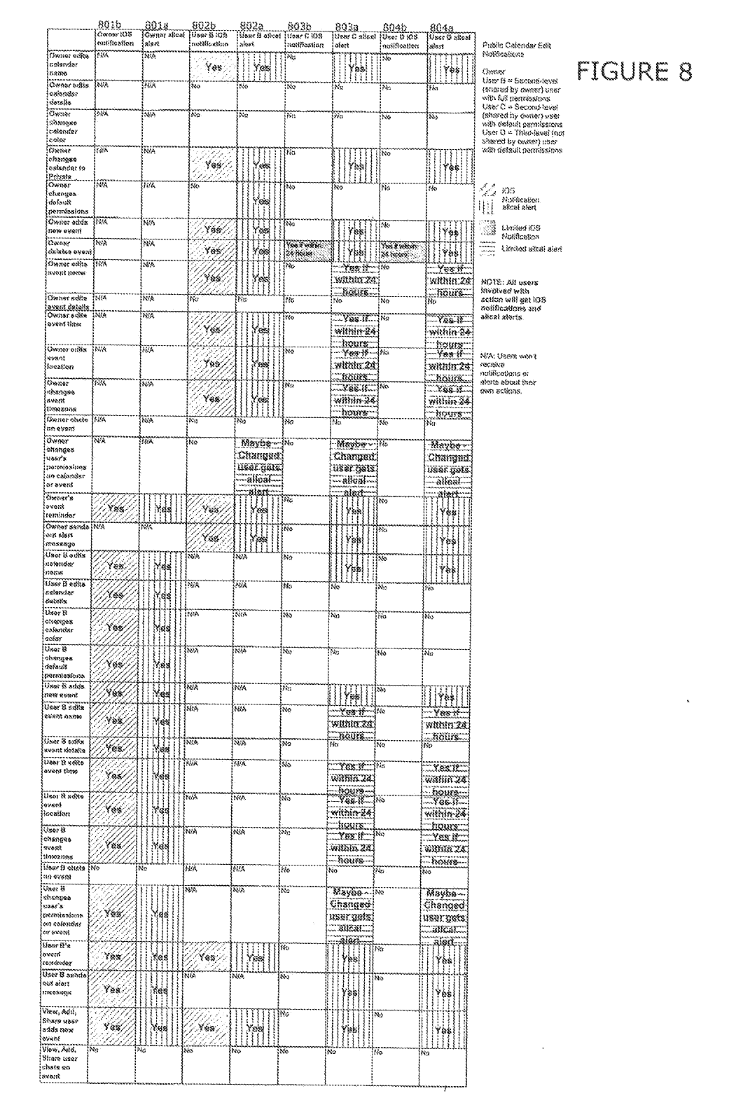

FIG. 9 depicts permissions for a public calendar in accordance with one embodiment. In this example, the types of permissions shown are: no permissions (not yet shared on calendar) 901, View only 902, View and Add 903, View and Share 904 (which is the public calendar default in the embodiment of FIG. 9), View, Add, and Share 905, View, Add, and Edit 906, View, Share, Add, and Edit 907, and Owner permissions 908.

Other embodiments include more refined or additional tiers of notification, such as email, text messages, or push notifications. In some embodiments, the notifications are fully or partially configurable by the user.

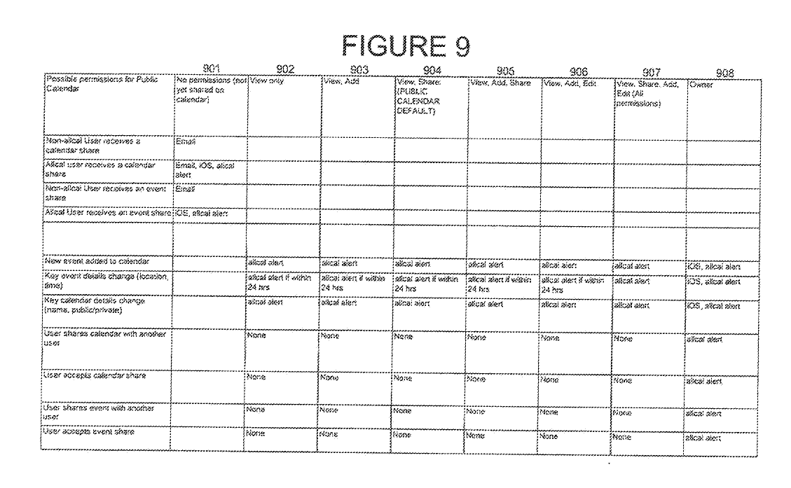

FIG. 10 depicts a screen capture of a view of the user interface in accordance with an embodiment. The screen capture of the user interface in FIG. 10 shows that the user has both private calendars 1001, and public calendars 1002. Disclosed embodiments allow for a user to view multiple calendars in her collection of calendars. This collection may include, for example, the user's personal calendar, a work calendar, a friend's private calendar that was shared with the user, and/or a public calendar of a favorite sports team or other organization. Events in these calendars can be linked to the original calendar in which they were created. For example, if the user's friend updates an event on a personal calendar, the event is also updated in the version seen by the user. Additionally, if the user had linked a friend's event into a personal calendar, the event details would update there as well.

The following exemplary use cases depict the various ways that the flexible e-calendar system can be utilized for different sizes of groups and for different purposes. These examples are for illustrative purposes and should not be understood as limiting the scope of the invention in any way.

| | | |
|---|---|---|
| | Type of Group | Size of Group |
| Use Case | [Public/Private] | [Small, Med, Large] |

| | | | |
|---|---|---|---|
| 1. | Single Family | Private | Small [2-12] |
| 2. | Friend's vacation | Private with Public | Small [3-10] |
| | together | aspects including | |
| | | photo/video/text | |
| | | sharing | |
| 3. | Alcoholics Anonymous | Public or Private | Large [MMs] |
| 4. | Toastmasters | Public or Private | Large [MMs] |
| 5. | Church (also Mega- | Public or Private | Medium [50-500] |
| | Church) | | |
| 6. | Sorority | Public or Private | Medium [50-250] |
| 7. | Hospital Stay | Public or Private | Medium to Large |
| | | | [250-1,000] |

| | |
|---|---|
| | Description: Consider a family of four, two |
| | spouses and two teenage kids. Each has an IOS |
| | device that they carry continuously with them. |
| | Each has their own lives to keep up with, and |
| Title: Single Family | yet they are all entwined. |

Details:
Father: One personal calendar, in which he allows spouse full access which is defined as
all permissions, but he maintains the basic owner rights. He also has rights to his
spouses' calendar with a read and write, but not edit, so he can see all her
appointments, and write new ones, but cannot edit other appointments he did not
write. Same read and write access, but not edit to both kids calendars.
Mother: One personal calendar, in which she allows her spouse to have read and write
permissions, and possibly read or limited read permissions to her kids. Limited read
would allow her kids to see only titles and dates/times, or possibly just dates/times, but
no descriptions or chat.
Kids: each has a personal calendar and some access to their mother's. They may or may
not have access to each other's.
All four will be capable of creating an event in their own calendar, and easily seeing the
other three, can invite any or all to the event.
The mother will be able to create an event in any person's calendar inviting any or all to
that event.
Each person opens their collection of calendars, and they see their particular schedule,
and can swipe to see the others in their family, or what part of it they are allowed.
Start with one simple invite from one family member to each ones email, and they select
option to automatically accept all invitations from that user “accept - Always,” plus they
download the app and put in their name, password, and email to begin their account. It
should be mentioned here that accepting invites does not mean you are attending the
event. Attending is a separate matter that can be addressed later.

| | Description: Consider five persons that are |
|---|---|
| | traveling together on a vacation. They need |
| | something to coordinate what they are doing |
| | and when. They will use an embodiment of |
| Title: Friends' Vacation Together | the invention. |
| Details: | |

Each person has their own personal calendar, but they are only going to use the single
vacation calendar that one of them sets up and give each person either full access or
read/write access to all events and communications.
If any one person thinks of something they want to do, they can propose it by writing the
event, and in the description saying it is a proposition, what does everyone think? Then
each person may immediately see this event and communicate through chatting.
Once events are in place, all parties may chat on the calendar itself and on individual
events.
Any change to the event's time or schedule will be immediately seen by all five persons
When an event is near - say 1 hour before - any person can look at the event and see
the other four and how much travel time they have to the event. This is complicated,
and usually done when invited to a specific event, and this is the entire calendar that
each has been given access to. Alternatively, this may only work when the individual
members are invited to a particular event, which is quite possible.
To begin with, one person creates the calendar and it is a Private Calendar (not personal
or public) and then that person invites with appropriate access the other four people to
gain access and privileges to this calendar.
Why are we creating a new calendar, rather than just inviting each other to all the events
from our personal calendar. Because of rights and permissions. Because in real life, it is
separate. This calendar represents something different and separate than our personal
calendar. Same thing for a school calendar, or work calendar.
Each person accesses the system and if the last time they were looking at this private
calendar, then it comes up where they left it. It functions as much as possible the same
as a personal calendar that everyone has complete access to.
Each person, if allowed knows who else has access to it
References and Notes:
The 5 person vacation can be similar to any group, such as a book club or soccer team,
etc.
Picture and video sharing throughout the trip to that group. The user can (a) invite
family and friends to the calendar of the trip to show them their photos and videos;
and/or, (b) user can either select option for calendar system to automatically send all
trip photos and videos to Facebook, twitter, other social media or user can select and
post specific photos and videos to Facebook, twitter, etc. to lessen the steps to do both.
Attach geo location to each photo and video

| | |
|---|---|
| | Description: A member of AA who travels |
| | frequently for business and leisure wants to be |
| | able to maintain his daily AA meetings. Finding |
| | meetings in new locales takes searching on |
| | AA.com and/or calling for information on time, |
| Title: Alcoholics Anonymous | location and focus of meetings. |

Details:

| | |
|---|---|
| 1. | User loads the “Global AA Calendar” by searching via keywords for “Alcoholics |

| Anonymous” and because this is a public calendar, user is able to add it to his or her | |
|---|---|
| collection of calendars. | |
| a. | Public Organizations/Groups can “advertise” their group calendar to (1) everyone; or, |
| | (2) contextually appropriate individuals, that are users of the system to “load their |
| | calendar”. A user can simply click on the banner ad which will load the calendar into |
| | that users' account. This functionality for “one click add of a public group calendar” |
| | can be extended to any banner ad on the internet. If you are a “member” of the |
| | system, it will simply add to your account; but, if you are not a member, following |
| | the initial ad click, you are taken to the normal sign-up screen. Following sign-up, the |
| | group calendar you wanted to add will be automatically added. |

| 2. | When a user is planning a trip, they can either proactively (a) search by city, state, |
|---|---|
| | country; (b) search via zip code/postal code for meetings; (c) search near an address [i.e., |
| | their hotel, office, etc.] for the nearest meeting; or, reactively find the nearest meeting |
| | to them by initiating the “find the closest meeting” based upon parameters of meeting |
| | type (i.e., open/closed, group share, etc.) |
| 3. | When the meeting location is found, it will display the days/times of meetings and “type |
| | of meeting”. |
| 4. | The user will click the meeting they want to attend. If it is an open meeting, the meeting |
| | data is added to their calendar; or, if it is a closed meeting (requires an invite or |
| | “authorization” for attendance), it will send a “request to attend” to the meeting |
| | organizer and they can approve. Once approved, the meeting is added to the users' |
| | calendar. |
| 5. | Reminders, Alerts and updates are sent in the same fashion as normal. |
| 6. | When an AA member attends a meeting, they can one-click connect to other members |

only with their approval. This supports the ability to “call a friend” when needed. The
ability to contact members of a calendar or attendees of an event is configurable by the
owner of the event or others with requisite permissions.

Reference and Notes:

The events could be linked to digitized AA materials and even contextualized to the
type of meeting.
Because the user account is secure, it will maintain anonymity.

| | |
|---|---|
| | Description: A user of the system wants to find |
| | and attend Toastmasters' meetings in her area |
| | and other areas she travels to. She also wants |
| | to increase her opportunity to learn from other |
| | members by reviewing videos of herself and |
| | others presenting with feedback and score |
| Title: Toastmasters | from fellow members. |

Details:

| | |
|---|---|
| 1. | Duplicate most of the approach with AA. |
| 2. | Features during the meeting: |

| | |
|---|---|
| a. | Ability to video speakers and upload those speeches to the “sub-group” (only those |
| | in attendance at that particular meeting) which would require RSVP/Check In by each |
| | attendee to receive these videos. |
| b. | Ability for each attendee to rate each video with a Likert Scale with additional notes |
| | to support the speaker's performance if they would like to add. |

Reference and Notes:

Toastmasters could categorize, rank, rate and file these videos for broader use
(assuming permissions approved) within the Toastmaster community creating
further interactivity between members globally. This could turn into the “platform”
for entries into the toastmaster competitions.

| | |
|---|---|
| | Description: |
| | Churches have a need/demand to maintain |
| | and communicate schedules of services, |
| | church school classes (e.g. Sunday School and |
| | other classes), groups including teens/youth |
| | groups, young children, choir and choir |
| | practices, elderly, ladies group, external groups |
| | that meet within the church including boy |
| | scouts, day care, AA/NA, etc. For some events |
| | such as Sunday services, special services |
| | including Christmas and Easter holidays, there |
| | is a need to consistently communicate to the |
| | entire congregation at a public level the details |
| | of these events. For the other “sub-groups”, |
| | for which some are private, additional |
| Title: Church (Mega-Church) | calendars are needed. |

Challenges that churches' have that embodiments of the invention can address, include:

Quick and effective communication of closures of part/all of the church facilities due to
weather and other unplanned for events.
To reserve and communicate the reservation of facilities such as rooms, kitchen, organ,
piano, administrative services and resolve conflicts.
Easily create and administer public calendars on the Church website
Offer visibility and “control” of church facilities in a central manner by the pastor and
administrative staff and volunteers.

Public Calendar events that would be built include the following. This “Main Church Calendar”
could be displayed on the church's website and maintained by a volunteer(s) and/or a church
administrator.

Sunday Service(s)
Wednesday Service(s)
Sunday school classes
Special holiday Services - Christmas, Easter, etc.
Days/Times when the church is open and closed
Days/times when the church office is open
Funeral Services - when the family desires it be public
Wedding Services - when the family desires it be public
Christenings/Baptisms - when the family desires it be public.
Organizations that hold their meetings at the church facilities including: AA/NA, Boy
Scout and Girl Scout troops, Ladies Club, etc. (NOTE: some of these groups will be open
and desire their calendar to be public and others will not and desire their calendar to be
private or privileged; however, there can be an “administrator view” of the church
facilities to show availabilities and bookings.)
Onsite day care center - facility and human resources that serve the day care facilities'
availability and any schedule/resources changes
Special public events such as a voting location, reception for a school team or group,
veterans and other groups.

Private Calendar Events can include the following list. These calendars are solely for the
membership of the church - actual church members - and not the general public.

Days/Times when the pastor is maintaining office/counseling hours
Events with the detail for new member classes
Choir practices and performances
Facilities, e.g., sanctuary, Sunday School rooms, playground, reception/meeting halls,
kitchen, library, parking Lots, some cleaning equipment, organ, pianos, other musical
instruments.

Example uses:

As a church member, I want the ability to review all the public events at the church.
As a church member that is also a member of a sub-group, I want the ability to review all
the private events of the group:

As a choir member, I want to see all choir practice events and communicate to
the choir director and all other choir members with updates and/or additional
information about choir related information.
As a Sunday school teacher, I want to be able to create and update events that
communicate to all of the members in our Sunday school class.
As a Church administrator, I want to be able to add and delete members to
private calendars.
As a Boy Scout troop leader, I want to be able to create, update and maintain the
Boy Scout troop calendar which includes the church administrator as a calendar
administrator.

As a Church administrator, I want to be able to create, update and maintain all public
and some private calendars.
As a church pastor, I want to be able to create, update and maintain all public and all
private calendars.
As a Church administrator, pastor or other delegate by the previous, I want to be able to
create, update and maintain facilities calendars.

As seen above, embodiments of the invention enable various individuals, groups, and sub-
groups to have different privileges, responsibilities, and abilities with regard to a single activity
type, i.e., church. Thus, one calendar (or, if desired, multiple calendars) can be used to facilitate
planning, scheduling, and logistics, while maintaining the levels of privacy desired for each type
of activity.

| | |
|---|---|
| | Description: Consider a group of young |
| | sorority members who are active in several |
| | clubs and school events. The students need a |
| | way to keep up with all public & private |
| | meetings and events, as well as keep track of |
| Title: Sorority | private events with friends. |

Details:

| | |
|---|---|
| 1. | Sorority's public calendar keeps track of events hosted by the Sorority. These events could |
| | be attended by people who are not in the Sorority, and are therefore searchable through |
| | the e-calendar system. This could be especially useful during Rush (recruitment of new |
| | members at beginning of each year). Only calendar owner and members with the right |
| | permissions can add events. |
| 2. | Sorority's private calendar includes events hosted by the Sorority that are only for members |
| | of the Sorority. This calendar would only be seen and searchable by calendar subscribers. |
| | Calendar owner can decide who can add event - allowing all subscribers to add event is an |
| | option. |
| 3. | Smaller group within Sorority creates another private BFF Calendar to plan events with |
| | closest friends (2-10 people). Can see which friends in groups are attending which event, and |
| | can chat about event on calendar. Subscribers can add pictures, video, information to any |
| | event. Calendar owner can decide who can add event - allowing all subscribers to add event |
| | is an option. |
| 4. | One student also joined University's Panhellenic Council. The group has a private calendar |
| | where it lists meetings, events and deadlines. The student adds this calendar, because she |
| | has to attend every event. |
| 5. | Another student wants to keep up with University's athletic events, so she adds the |
| | public University Athletics Calendar. This includes all sports (3-4 daily), but student will not |
| | attend all. She may share some events on the private Sorority calendar so other members of |
| | the group know about them and can attend. |
| 6. | Student also uses public University Football Calendar, which includes all football games. |
| | Student can share football game event with friends on private BFF calendar, then chat about |
| | what time they're going to meet, etc. |

References and Notes:

A BFF calendar would be unique. Instead of planning things through “group text
messages,” there would be one place where the group could primarily plan events
together, but also interact about future and past events.

| | |
|---|---|
| | Description: |
| | During Hospital stays, individuals want to know |
| | the latest, information including, when and |
| | what doctors are coming and what they are |
| | saying, when caretakers are taking turns |
| | staying during the day and night, and what |
| | they are all doing and finding out each day. |
| | Embodiments of the e-calendar system can be |
| Title: Hospital Stays | used to coordinate such things |

Details:

| 1. | Home-cooked meals. Families can create a family and friends calendar and share when |
|---|---|
| | and what they may be cooking, such that extra food or meals could be cooked and |
| | shared among the group. The cook could put the event on the calendar, saying what |
| | they care cooking and about how much could be cooked if others want some, and the |
| | chat feature allows pictures and videos and communication among the group |
| | coordinating the event. Also a detailed record is recorded, so that credit is allowed, and |
| | others can perform similar acts to equal out the bargain. |
| 2. | If a person schedules family care givers to be present at certain times the gps could tell |

the person that they were close and coming and then here. Later, when the person
looks at the record, he can look back and see they were here from this time to this time.
Plus, the invention app allows users to make corrections on the fly and have peace of
mind.

As described and claimed in co-pending U.S. patent application Ser. No. 14/698,435, the system and method set forth above may further comprise an estimated time of arrival (“ETA”) component that updates attendees of a meeting with location information of other attendees of the meeting. In particular, the disclosed system and method may include or incorporate an ETA component that provides attendees of a meeting with location information (based on global positioning system (“GPS”) data, cellular data, or other positioning data, collected, for example, from each attendee's mobile device) for other attendees of the meeting. Some embodiments allow users to include this functionality in some calendars or events, but not others. Some embodiments allow users with requisite permissions selectively to apply this functionality to certain event attendees or certain users sharing the calendar. Some embodiments further enable individuals to decline the ETA functionality (such that other individuals cannot see relevant location information) in totality or for a particular meeting or calendar.

For example, in the event that multiple users are expected to meet at a location for a scheduled event or other gathering, users opting in to this particular feature may broadcast (from a mobile telephone or other wireless device) location information to other users such that those other users may be apprised of the whereabouts of an absent or tardy attendee. In that regard, a calendar application may request location information from a GPS, navigational, or other positional processor or software application resident on or associated with a particular user device. Such positional data and attendant processors and software support are generally known in the art, as are navigational software packages that estimate travel time from a particular location to a desired destination—the present disclosure is not intended to be limited to any particular software or hardware implementation enabling location of a particular user device in three-dimensional space or estimation of travel time to a specific destination. In accordance with some embodiments, such positional data may be shared via a calendar application to other users who are to attend an event.

In the foregoing manner, an integrated calendar and positional determination system and method may estimate the time of arrival for one or more attendees of an event, and broadcast or otherwise selectively communicate that information to other attendees. In the event that a number of expected attendees are assembled, for example, outside an event venue and are waiting for the arrival of one or more other expected attendees, an integrated calendaring system and method may apprise those waiting of the location and expected arrival times of those who are currently not in attendance.

In some embodiments, it may be desirable to integrate a calendar application with ticket acquisition and management functionality. In that regard, aspects of the disclosed subject matter may leverage the foregoing calendaring methodologies in an integrated system and method that allow for association of tickets or other admission tokens with a calendared event. In many situations, it may be desirable to allow a user to transfer ownership or usage rights of a ticket to a third party. A brief overview of this functionality is set forth below.

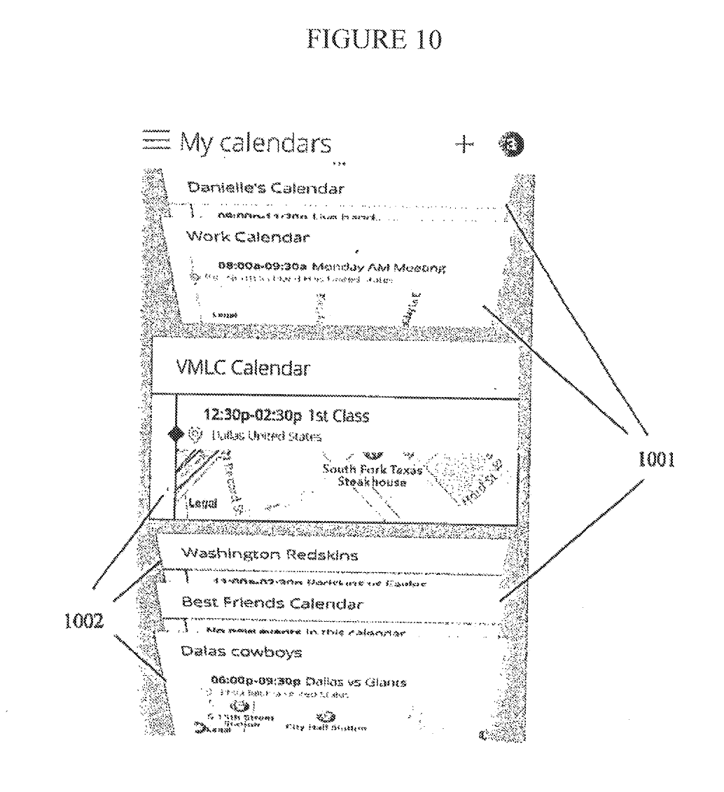

As shown in FIG. 11, user devices 1110 may be coupled to a ticket manager component 1190 via a network 1170 (such as the Internet). Additionally or alternatively, user devices 1110 may be coupled to ticket manager 1190 via a proprietary network 1171, illustrated as an option in FIG. 11. Ticket manager 1190 may communicate directly (dashed line) to a third party ticket creation and distribution engine 1180; additionally or alternatively, such communication may be via network 1170.

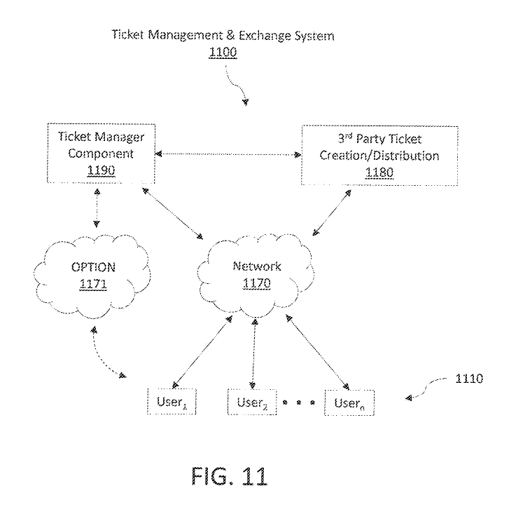

In a departure from conventional technologies, user devices 1110 may include functionality that tightly couples a calendaring application with ticket management for regulated access or permitted entry to calendared events. As illustrated in FIG. 12A, a user device 1110 may tightly couple a calendar application 1115 with a ticket manager functional block 1116, or these functionalities may be integrated into a single calendar application 1119 having enhanced ticket purchase, sale, and management capabilities with respect to calendared or proposed events. Some relevant functional blocks associated with ticket manager 1190 are illustrated in FIG. 12B.

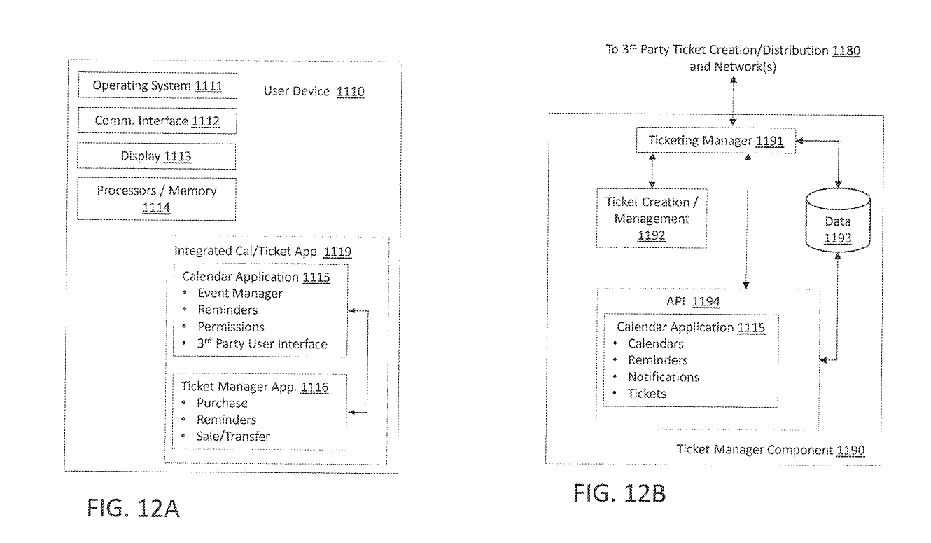

As illustrated in FIG. 13A, in cooperation with the calendar application 1115 and the ticket manager application 1116, a user device may execute a method comprising: acquiring a ticket on behalf of a ticket holder (1310); associating the ticket with a calendar event (1320); confirming the association with a remote ticket manager component (1330); enabling the ticket holder to transfer the ticket to another user (1340) (this may optionally occur with the assistance of, or in cooperation with, the remote ticket manager component); and transmitting data regarding such a transfer to the remote ticket manager (1350). One embodiment of acquiring a ticket is illustrated in FIG. 13B.

In more detail, it will be appreciated that FIG. 11 is a block diagram illustrating one environment in which ticket management functionality may be integrated with a calendar application. A ticket management and exchange system 1100 may generally comprise user devices 1110 coupled to, or in bi-directional data communication with, ticket manager component 1190. As noted above, this connection may be via a general communications network 1170 (such as the Internet) or via a proprietary network 1171 such as may be maintained by an entity that also controls or operates ticket manager 1190. Additionally, ticket manager 1190 may communicate directly with third party ticket creation/distribution engine 1180, or may engage in relevant data communications via network 1170. It is to be understood that the present disclosure is not intended to be limited by any particular network architecture or by the particular communications protocols employed to enable the networked interoperability of the illustrated components.

FIG. 12A is a block diagram illustrating functional blocks of one embodiment of a user device illustrated in FIG. 11. As is generally known in the art, user device 1110 may generally comprise and operating system 1111, a communications interface 1112, a display 1113, and processors working in cooperation with memory 1114. Modems, cameras, input/output devices, and other functional elements of user device 1110 are omitted for clarity, but it will be appreciated that user device 1110 may be embodied in or comprise any of various wireless or cellular telephones, tablet devices, pagers, personal digital assistants, laptop or notebook computers, and the like. The disclosed subject matter is applicable to any user device 1110 having networked communication capabilities and calendaring functionality as set forth herein.

As noted above, user device 1110 may tightly couple calendar application 1115 with ticket manager application 1116. In FIG. 12A, these functionalities are illustrated as aspects of an integrated calendar application 1119 having enhanced ticket purchase, sale, and management capabilities with respect to calendared or proposed events. In that regard, calendar application 1115 may perform various scheduling and reminder functions such as are generally known in the art. For example, calendar application 1115 may include an event manager and provide reminders for scheduled events. In some implementations, calendar application 1115 may provide permissions functionality and 3^{rd} party user interface hooks, such that a 3^{rd} party having sufficient permissions may view, add, modify, or delete calendared events as set forth in detail above.

Typical calendaring applications do not contemplate use in connection with ticket manager application 1116, however. In operation, ticket manager application 1116 is tightly coupled with calendar application 1115, meaning that it has sufficient access to application programming interfaces (APIs) or other software or firmware hooks to interact with, and to influence the operation of, calendar application 1115. In that regard, background or underlying operation of ticket manager application 1116 may be transparent to a user of user device 1110, as the only interaction necessary is through the user interface mechanism associated with calendar application 1115 itself, or the user interface of integrated application 1119.

As illustrated in FIG. 12A, ticket manager application 1116 may generally include functionality to allow a user to purchase tickets, to provide reminders of ticketed events, and to allow the sale or transfer of tickets to another user. As noted above, it may be desirable in some instances to enable the foregoing and other functionality directly through the user interface of calendar application 1115 (or more particularly, integrated application 1119); in other embodiments, ticket manager application 1116 may comprise an independent user interface, for example, to enable account registration or modification, to set or alter settings or permissions, to enter and store credit card or payment information, and the like.

In operation, functionality of ticket manager application 1116 (either independently or through integrated application 1119) may benefit from bi-directional data communication with ticket manager component 1190. FIG. 12B is a block diagram illustrating functional blocks of one embodiment of a ticket manager component illustrated in FIG. 11. In the illustrated embodiment, ticket manager component 1190 generally comprises a ticketing manager 1191, a ticket creation/management component 1192, a data storage component 1193, and an API 1194 enabling an interface with calendar application 1115 (or integrated application 1119).

Ticketing manager 1191 oversees and manages all ticket transactions for users of system 1100, as well as bi-directional data communication with networks 1170, 1171 and third party ticket creation/distribution engine 1180. Ticketing manager 1191 may be embodied in or comprise a microprocessor, a microcontroller, or some other similar data processing hardware component operating in cooperation with memory and instruction sets (such as software or firmware); memory and controllers, modems and network interface cards, and specific software or firmware functional blocks associated with operational characteristics of ticketing manager 1191 are generally known in the art, and so are omitted from FIG. 12B for clarity. In operation, ticketing manager 1191 receives, acknowledges, records, and transmits, among other things, data associated with ticket generation, ticket offers, ticket purchases, ticket sales or transfers, and ticket redemption; it will be appreciated that the foregoing and other data are all associated with particular calendar events, and so ticketing manager 1191 operates in cooperation with API 1194 to identify and record which ticket-related data are associated with a particular calendar event as maintained by calendar application 1115. In the FIG. 12B embodiment, calendar application 1115 is an instantiation of the same calendar application 1115 stored on and accessed by user device 1110, though it may be desirable in some instances to implement a different type of calendar application at ticket manager component 1190 than that implemented at user device 1110. As long as API 1194 and ticketing manager 1191 are suitably programmed and operative to perform proper translation of data, it is not necessary to utilize the same calendar application 1115 at both ticket manager component 1190 and user device 1110.

Ticket creation/management component 1192 may generally be employed to generate tickets or admission tokens for a particular event. This may be at the command or request of the entity controlling ticket manager component 1190 or by a third party. For example, if a particular rock band is performing at a particular venue on a particular date, the band's manager or promoter may access appropriate software and make a certain number of tickets available to users of system 1100 via ticket creation/management component 1192; similarly, a museum curator could do the same thing, making tickets for a new exhibit available to users of system 1100. Alternatively, where the operator of ticket manager component 1190 interacts directly with the band promoter or the museum curator to acquire a certain number of tickets or admissions tokens, then the operator may make such tickets available, again via ticket creation/management component 1192. As with ticketing manager 1191, the foregoing functionality may be supported or enabled by one or more processing elements, memory stores, instruction sets, user interface mechanisms, and possibly even a dedicated network or communications interface; these elements are generally known in the art and are omitted from FIG. 12B for clarity.

At the point of ticket generation in the illustrated embodiment, however, the tickets made available as contemplated above have not yet been associated with a particular calendar event that is recognized by calendar application 1115. Ticket-and event-specific data made available via ticket creation/management component 1192 may be processed by ticketing manager 1191, for example, and correlated (via API 1194) with calendar-specific data resident at or accessible by calendar application 1115; as illustrated in FIG. 12B, this correlation of data may occur by direct interaction between ticketing manager 1191 and calendar application 1115, or it may occur indirectly, via access to relevant data stored in or resident on data store 1193 and accessible by both of these components.

Upon association with a specific calendar event (by, for example, ticketing manager 1191 ), ticket data may then be acknowledged by and accessible to calendar application 1115 (as indicated in FIG. 12B) and stored in data store 1193 for future use or transmission by components of ticket manager component 1190.

It will be appreciated that the functionality of third party ticket creation/distribution engine 1180 illustrated in FIG. 11 is substantially as set forth above with reference to ticket creation/management component 1192. Specifically, third party ticket creation/distribution engine 1180 may generally be employed to generate tickets or admission tokens for a particular event, making tickets for a specific event available to users of system 1100. At this point, interaction between third party ticket creation/distribution engine 1180 and ticketing manager 1191 and other functional blocks of ticket manager component 1190 may generally proceed as set forth above. In operation, ticketing manager 1191 may perform the same functions irrespective of the source of ticket data.

FIG. 13A is a flow diagram illustrating aspects of a method of acquiring and managing a ticket. As illustrated in FIG. 13 A, a ticket may be acquired on behalf of a ticket holder (reference numeral 1310). In one embodiment, this may be executed by or at user device 1110, for example, in cooperation with calendar application 1115 and ticket manager application 1116. For instance, ticketing manager 1191, having received ticket and event data (from ticket creation/management component 1192 or from third party ticket creation/distribution engine 1180), and having associated those ticket and event data with specific calendar data as set forth above, may employ API 1194 and transmit an appropriate invitation or notice to users of system 1100—as noted above, such transmission may be in accordance with user account settings, preferences, or permissions, in some cases. Users having received such invitation or notice (e.g., via a user interface associated with calendar application 1115 or integrated application 1119) may elect at that time or otherwise at a later time, to purchase, accept, or otherwise to acquire a ticket or admission token.

Such a ticket or other token may be associated with a specific calendar event at calendar application 1115 or integrated application 1119 (reference numeral 1320). It will be appreciated that this association may occur at user device 1110 (after communication of the ticket and event data) or at ticket manager component 1190 (prior to communication of the ticket and event data to user device 1110). In any event, purchase or other acceptance of the ticket and appropriate association of ticket data with a calendar event may be confirmed with ticket manager component 1190 (as indicated at reference numeral 1330). This is a matter of updating ticketing manager 1191 that calendar application 1115 at user device 1110 has recorded or otherwise stored an event requiring an admission token (and that appropriate payment arrangements have been made), so that ticketing manager 1191 may reconcile records at data store 1193 accordingly.

As indicated at reference numeral 1340, one embodiment may enable a ticket holder to transfer a ticket or token to another user; this may optionally occur with the assistance of, or in cooperation with, remote ticket manager component 1190. For example, a first user of system 1100 (U1) may employ a user interface at calendar application 1115 (for instance), to communicate to ticketing manager 1191 a command or a request that a particular ticket or set of tickets be transferred to a second user of system 1100 (U2), in exchange for compensation or otherwise. Upon appropriate processing at ticket manager component 1190, the command or request may be communicated, again through ticketing manager 1191, to U2, who may accept or decline the transfer. In any event, the request, transmission, and outcome of the purported transfer may be recorded by ticketing manager 1191, for example, in updated records at data store 1193. It will be appreciated that, in some cases, it may be desirable (for instance, based upon user preferences and account data, among other factors) that ticketing manager 1191 coordinate or otherwise facilitate monetary exchanges or payments as between users U1 and U2. As an alternative, and where U1 and U2 are employing user devices 1110 appropriately equipped for peer-to-peer or other near field communications protocols, U1 and U2 may conduct and consummate a ticket transfer (including satisfaction of payment obligations, where applicable) locally, in which case a user device 1110 associated with U1, U2, or both, may communicate data representative of the transaction to ticketing manager 1191, either in real-time, near real-time, or after the fact, such that ticket manager component 1190 (i.e., ticketing manager 1191, in particular) is suitably apprised of the transaction and may update records in data store 1193 accordingly. In that regard, the FIG. 13A embodiment contemplates transmitting data regarding such a transfer to remote ticket manager 1190 (reference numeral 1350), though it is noted, as indicated above, that ticket manager component 1190 may be integral with, and facilitate, the transaction in the first place.

FIG. 13B is a flow diagram illustrating aspects of a method of acquiring a ticket as illustrated in FIG. 13A. As indicated at block 1311, a first user of system 1100 (U1) may acquire a ticket. As set forth above with reference to FIG. 12B, this may acquisition may occur through interaction with ticketing manager 1191, either in cooperation with ticket creation/management component 1192, third party ticket creation/distribution engine 1180, or both, and in any event subject to an interaction between ticketing manager 1191 and AR 1194 associating ticket data with calendar information. Alternatively, this acquisition may occur locally (i.e., without intervention on the part of ticketing manager) via peer-to-peer or other communications between calendar applications 1115 (or integrated applications 1119) installed on or accessible by respective user devices 1110.

In one embodiment; a user interface (e.g., of integrated application 1119) may provide functional elements or options to enable U1 to sell, assign, gift, or otherwise transfer ownership or use rights associated with a particular ticket or set of tickets to a second user of system 1100 (U2). Various user interface design features may be employed to enable this functionality; the present disclosure is not intended to be limited by the manner in which a particular user is prompted or otherwise enabled to offer up tickets or tokens for sale oar barter. This transfer is illustrated at reference numeral 1312. Just as with the original acquisition noted above, a sale or other transfer of ticket ownership or use rights may be effectuated either with or without intervention on the part of ticketing manager 1191, depending upon the preferences of U1 and U2 and the capabilities of each's respective user device 1110. In any event, it may be desirable to notify ticketing manager 1191 of the transfer such that ticket manager component 1190 may update records in data store 1193 accurately to reflect the status and ownership of each ticket or token affected by the transfer or sale.

Based upon information associated with a transfer as set forth above, the process may investigate whether U1 is still the owner of a particular ticket or set of tickets (reference numeral 1313 ); this may be effectuated by ticketing manager 1191, for instance, by reconciling records in data store 1193, calendar application 1115, or both, If so, the process loops back to block 1312. If not, ticketing manager 1191 may investigate whether U1 has retained any use rights in a particular ticket or set of tickets (reference numeral 1314). If so, U1 may still use the ticket, as indicated at block 1315. If not, U1 is recognized (by system 1100 and all of its constituent elements) as having surrendered all rights to use the ticket, as indicated at block 1319.

It will be appreciated that “using” a ticket in this context may include presenting or displaying a ticket, token, or other use rights at a gate or entry portal to an event. In that regard, a ticket as contemplated herein may include a bar code or other indicia that may be displayed, for instance, on a display 1113 associated with user device 1110 to be viewed or scanned by authorized personnel at a venue; additionally or alternatively, a ticket or entry validation token may be associated with a user name, alias, handle, or password associated with user device 1110, depending up the technology employed by the venue, the preferences of the user, ora combination of these and other factors. Though communication between ticket manager component 1190 and a particular venue is not illustrated in FIG. 11, it is contemplated that ticket manager component 1190 may communicate with a venue (such as a stadium, museum, airport ticket counter, or convention center, for example), either directly or via network 1170, to establish agreed upon or acceptable ticket redemption protocols that will influence operation of user device 1110 to enable admission to an event.

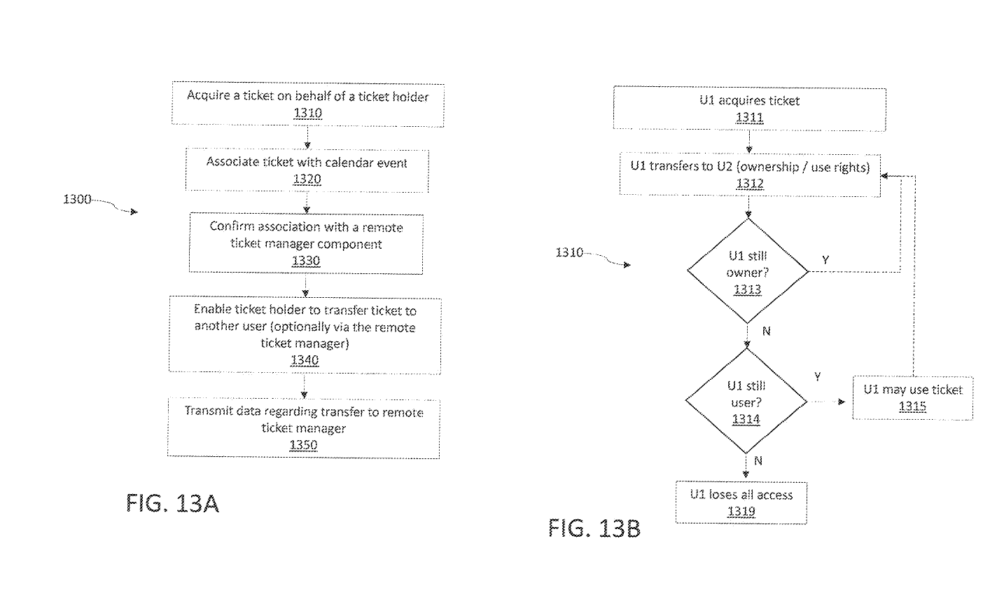

FIG. 14 is a flow diagram illustrating aspects of a method of managing a ticket, In the FIG. 14 embodiment, a process 1400 may involve a ticket manager component (such as 1190 in general, or ticketing manager 1191 in particular) associating a ticket with a calendar event (reference numeral 1410) as described above. Through permissions and other access rights, as set forth in detail above, a user (such as U1) may acquire rights to view calendar or scheduling details associated with the event for which the ticket is required (reference numeral 1420). As noted above, this may be through a user interface associated with calendar application 1115 or integrated application 1119. Via such a user interface or other appropriate mechanism associated with calendar application 1115 or integrated application 1119, a user may elect to purchase or otherwise to acquire (via gift, barter, or otherwise) ticket ownership or user rights (reference numeral 1430). In some embodiments, the same user interface may interoperate with other software applications or an integrated feature of calendar application 1115 to effectuate appropriate payment which is recognized, for example, by system 1100, in general, and by ticketing manager 1191, in particular.

As indicated at block 1440, notifications may be transmitted and a ticket may be associated with a particular calendar event; in the FIG. 14 embodiment, where block 1410 is effectuated at ticket manager component 1190, the notification may be transmitted to user device 1110 and the ticket association may be effectuated there, such as by calendar application 1115 or integrated application 1119 at user device 1110. Alternatively, for example in a peer-to-peer transaction context noted above, the transmission contemplated at block 1440 may go the other direction, i.e., from user device 1110 to ticket manager component 1190, where the appropriate association may be made and communicated to API 1194 and data store 1193.

Once the appropriate association has been made at block 1140, a user (say U1) may view ticket information and associated data (cost or transfer restrictions, for instance) in connection with the event. As indicated at block 1450, such viewing may occur, for example, via a user interface of calendar application 1115 or integrated application 1119; additionally or alternatively, such viewing may be made available via a website or other generic network connection, i.e., without the necessity for implementing a calendaring application of any description. Various forms of serving data in connection with formatting data to a web browser or other hypertext transfer protocol (HTTP) reader are generally known in the art, and may be employed to provide or otherwise to display calendar and ticketing information to a user via a website or other network accessible resource independent of user device 1110 and calendar application 1115.

In accordance with appropriate user permissions and access rights, a user may update or change information associated with a ticket, a ticketed calendar event, or both (reference numeral 1460). For example, if a ticket is required for an event, but the date may be variable (such as with theme park admissions or art museum exhibits, for example), a user having possession or control of a ticket may decide to attend on Friday rather than Thursday due to scheduling conflicts or personal preferences. In such an instance, that user may update the calendar information associated with the ticket without making changes or modifications to the ticket data associated with the event; additionally, calendar updates may be provided to colleagues or friends as set forth in detail above. It will be appreciated that in some instances (such as a one-time only concert event or the seventh and deciding game of Major League Baseball's World Series), event scheduling may not be subject to change at the user's option.

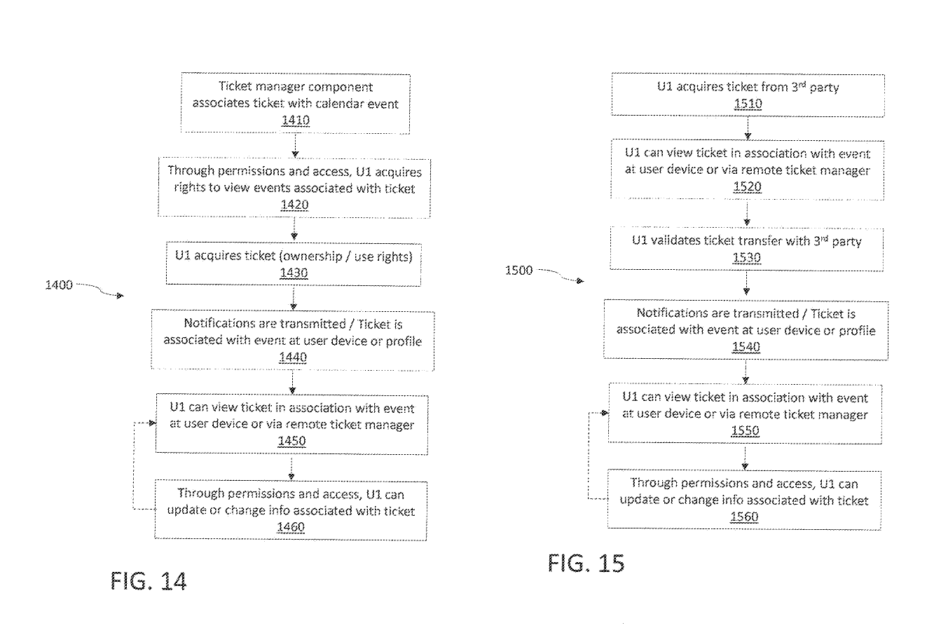

FIG. 15 is a flow diagram illustrating aspects of another method of managing a ticket, In the FIG. 15 embodiment, the method 150 begins when a user (say U1) acquires a ticket from a third party (reference numeral 1510) substantially as set forth above with reference to FIGS. 13A and 13 B. Upon acquisition, U1 may view relevant ticket and calendar information (reference numeral 1520) substantially as described above with reference to FIG. 14; this may be via a user interface at user device 1110 or via a web browser or other HTML reader, depending upon user preference or settings, network availability, and current availability of user device 1110, or a combination of these and other factors.

It may be desirable in some instances that U1 validates the ticket transfer as indicated at block 1530; as noted above, this may be a peer-to-peer or other communication between user devices 1110, for instance, or it may involve communication with third party ticket creation/distribution engine 1180, depending upon the source from which U1 acquired the ticket. In this context, validation generally includes U1 and the source of the ticket confirming with each other particulars associated with the sale, transfer, or barter of the ticket or attendant usage rights. For example, this may be peer-to-peer, employing user interfaces at calendar application 1115 or integrated application 1119 at respective user devices 1110, or it may employ ticketing manager 1191 either independently or in cooperation with third party ticket creation/distribution engine 1180, as a function of the source of the ticket or usage rights. In either case, U1 and the ticket source use appropriate hardware, software, and communications handshaking and protocols to exchange sufficient information to confirm that U1 has acquired the contemplated rights, and that the source has transferred same, in accordance with the agreement struck by the parties.

Subsequently, or possibly even concomitantly, notifications to appropriate elements of system 1100 may be transmitted as indicated at block 1540. Additionally, ticket data are associated with the ticketed event, such as at calendar application 1115 or integrated application 1119 at user device 1110, at calendar application 1115 and/or data store 1193 (see FIG. 12 B) at ticket manager component 1190, or both. In that regard, it will be appreciated that data store 1193 coordinates appropriate data records associating ticket and calendar data for each independent user of system 1100; accordingly, such data may be accessed by a particular user by accessing ticket manager component 1190 independently of calendar application 1115 or integrated application 1119 at user device, for instance, using profile preferences, passwords, or other login credentials as set forth above. Specifically, where appropriate web or Internet access is provided (as is generally known) via ticketing manager 1191 to resources including API 1194 and data store 1193 at ticket manager component 1190, it is not necessary to employ or otherwise to install integrated application 1119 or other proprietary software at user device 1110, though that may be beneficial for mobile use of calendaring functionality. The operations depicted at blocks 1550 and 1560 may proceed substantially as set forth above with reference to blocks 1450 and 1460 in FIG. 14.

It will be appreciated that the arrangement of the blocks representative of operations illustrated in FIGS. 13A, 13 B, 14, and 15 are provided by way of example, and is susceptible of numerous various. The orders of operations are not intended to excluded other possibilities.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A system for viewing and managing a collection of electronic calendars of a user, the system comprising:
an interface that enables the user to browse through the collection of electronic calendars and add or remove electronic calendars from the collection of electronic calendars; and
a ticket manager that enables the user to associate a ticket with a particular calendar event using the interface.

2. The system of claim 1 wherein the ticket manager allows the user o purchase the ticket which is required for attendance at the particular calendar event.

3. The system of claim 2 wherein the ticket manager allows the user to transfer the ticket to a third party.

4. The system of claim 3 whether in the ticket manager allows the third party to provide payment to the user n exchange for the ticket.

5. The system of claim 1 further comprising:
an ETA component that updates the user with information related to a location of a third party that is to attend the particular calendar event associated with the ticket.

6. A method of acquiring and managing a ticket, the method comprising:
acquiring a ticket on behalf of a ticket holder;
associating the ticket with a particular calendar event;
confirming the associating with a remote ticket manager component; and
enabling the ticket holder to redeem the ticket in exchange for admission to the particular calendar event.

7. The method of claim 6 further comprising:
enabling the ticket holder to transfer the ticket to a third party; and
transmitting data regarding the transfer to the remote ticket manager.
